(19) United States
(12) Patent Application Publication
(10) Pub. No.: US 2025/0235930 A1
(43) Pub. Date: Jul. 24, 2025

(54) DOWNDRAFT SYSTEM FOR BINDER JETTING ADDITIVE MANUFACTURING

(71) Applicant: Desktop Metal, Inc., Burlington, MA (US)

(72) Inventors: Kurt JOUDREY, Burlington, MA (US); Emanuel SACHS, Burlington, MA (US); Joseph JOHNSON, Burlington, MA (US); Martin BUJWID, Burlington, MA (US)

(21) Appl. No.: 18/838,614

(22) PCT Filed: Feb. 15, 2023
(86) PCT No.: PCT/US2023/013099

§ 371 Date: Aug. 15, 2024

Related U.S. Application Data
(60) Provisional application No. 63/312,295, filed on Feb. 21, 2022.

(51) Int. Cl. B22F 10/73; B22F 12/70; B28B 1/00; B29C 64/357; B33Y 30/00; B33Y 40/00

(52) U.S. Cl. CPC B22F 10/73; B22F 12/70; B28B 1/001; B29C 64/357; B33Y 30/00; B33Y 40/00

(57) ABSTRACT

A powder collection system for use in binder jetting additive manufacturing. A downdraft system includes at least one powder collection chute disposed in an interior of a binder jetting printer and adjacent to a print deck. The downdraft system is configured to receive an amount of excess build material powder dislodged from the print deck by a powder spreading process. A pneumatic conveyance system including at least one conveyance plumbing tube provides gaseous communication between the downdraft system and a powder collection unit. A gas management system provides a flow of process gas through the downdraft system and the pneumatic conveyance system at a rate sufficient to convey the excess build material powder received by the downdraft through the pneumatical conveyance system to the powder collection unit. The powder collection unit separates the excess build material powder from the flow of process gas and collects it.

### RELATED APPLICATIONS

This application is a US National Stage Application, filed under 35 U.S.C. § 371, of International Application PCT/US2023/013099, filed on Feb. 15, 2023 and claims priority to U.S. patent application 63/312,295, filed on Feb. 21, 2022; the contents of the above applications are incorporated by reference herein in their entirety.

### TECHNICAL FIELD

Various aspects of the present disclosure relate generally to downdraft gas management and build material powder management for binder jetting additive manufacturing.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. After printing, the bound part is removed from the excess powder, and sintered at a high temperature to bind the particles together. During spreading of the powder an excess amount of build material powder is employed to ensure that a sufficiently dense layer of powder is produced. This excess amount of build material powder is spread off the powder bed. Further, build material powder will migrate through the air in the binder jetting printer and fall off the side of the powder bed. The accumulation of excess build material powder presents a risk of combustion and can impair the operation of components necessary for printing operations.

### SUMMARY

Disclosed is a powder collection system for use in binder jetting additive manufacturing, where objects are fabricated from a build material powder (“powder”) and a binder. A downdraft system includes powder collection chutes disposed in an interior of a binder jetting printer and adjacent to a print deck. The downdraft system receives an amount of excess build material powder dislodged from the print deck by a powder spreading process. A pneumatic conveyance system includes conveyance plumbing tubes providing gaseous communication between the downdraft system and a powder collection unit. A gas management system provides a flow of process gas through the downdraft system and the pneumatic conveyance system at a rate sufficient to convey the excess build material powder received by the downdraft system through the pneumatic conveyance system to the powder collection unit. The powder collection unit separates the excess build material powder from the flow of process gas and collects the excess build material powder.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIG. 3. is a perspective view of a binder jetting printer according to an exemplary embodiment of the present disclosure.

FIG. 4 depicts a top schematic view of a gas management system according to an exemplary embodiment of the present disclosure.

FIGS. 5A-H depict another gas management system according to an exemplary embodiment of the present disclosure.

FIGS. 6A-C depict baffle systems for use in powder collection chutes according to an exemplary embodiment of the present disclosure.

FIG. 7 depicts a theorized powder chute defining a chute angle.

FIG. 8 depicts a first alternative powder chute design having a source of vibration for encouraging powder migration.

FIGS. 9A-B depict a second alternative powder chute design.

### DETAILED DESCRIPTION

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

In certain embodiments, a binder jet printer may comprise a print enclosure with a number of modules configured to aid in or accomplish the additive manufacturing of parts and other objects from a build material powder. These modules may include: (1) an assemblage of printheads (or one printhead in certain embodiments), (2) an ink delivery system to supply the printheads with binder at flow and pressure conditions necessary for stable binder ejection from the printhead, (3) a build material supply module to deliver an amount of build material powder to a print surface (also known as a work surface or a build surface) within the printer, (4) a build material spreading module to spread an amount of build material powder which has been supplied to a print surface (or work surface, or build surface) to a controlled thickness, (5) a container and motion system to contain the build material powder and during printing move the container to specific positions (e.g., by moving in a first direction relative to a least one of the modules (1)-(4)) to enable the fabrication of successive layers of an object. In some embodiments, the printer may comprise additional modules including: (6) devices configured to reduce, prevent, or remove build material powder and/or ejecta from the printhead that may become suspended in an atmosphere in the print enclosure, including, according to certain embodiments, devices which deposit liquids (e.g., water, alcohol, oils, and the like) onto a surface of the build material powder to alter the cohesive characteristics of the powder, devices which control and/or provide a flow of gas to remove and/or filter suspended ejecta, (7) devices configured to control the gaseous atmosphere within the print enclosure relative to a gaseous atmosphere surrounding the binder jet printer, and (8) at least one reciprocating mechanism to provide relative motion between the container containing build material powder and at least one of the modules (1) to (4) in a second direction different from the first direction of the container and indexing system.

Build material powders may be sensitive to certain gaseous atmospheres. According to certain embodiments, it is desirable to prevent, minimize, or otherwise avoid gaseous communication between certain gaseous species and specific metal powders. For example, a copper build material powder may oxidize when in contact with air. In certain embodiments of the binder jetting printing process, such an oxidation of copper may be deleterious to the printing process for at least the reason that the oxidation may be uncontrolled and may introduce uncertainty into certain aspects of the binder jet printing process. In certain embodiments, a build material powder may be reactive (e.g, pyrophoric or explosible) with moisture and the build material powder should be kept separate from a base level of moisture contained in ambient air (e.g., room humidity). In certain embodiments, a build material powder may not be chemically sensitive (e.g., prone to oxidation, explosibility, pyrophoricity, or other means of chemical reaction) but may exhibit a change in physical properties such as the ability of the build material powder to flow. In the case where the flow characteristics of the powder will vary, degrade, or otherwise change, maintaining a consistent atmosphere around the build material powder may be required.

In another embodiment, build material powders may be reactive (e.g. pyrophoric or explosible) in the presence of oxygen and ignition sources capable of providing energy above the minimum ignition energy or temperatures above the minimum ignition temperature of the powder. Certain of the process modules (1) to (8) may provide sufficient energy or temperature to exceed these ignition limits, creating a condition in which a reaction may occur. In such cases, it may be desirable to maintain the printing environment in an inerted state, with the oxygen concentration of the atmosphere maintained below a predetermined concentration which is lower than the limiting oxygen concentration, or the concentration below which combustion of the build material powder does not readily occur. A typical target oxygen concentration may be 2%, which is below a typical limiting oxygen concentration of 4-18% for commonly printed materials. In the process of binder jet additive manufacturing, a build material powder is typically supplied to a binder jet printer and some amount of this build material powder is bound using a binder to form objects. These objects are provided with various names in the field of art, and may be referred to as green parts, but are sometimes also referred to as brown parts. In certain embodiments, the objects formed may include parts that, as one skilled in the art will appreciate, may undergo subsequent post-processing steps (perhaps including a curing, drying, or crosslinking step) to improve the mechanical properties (such as strength, fracture toughness, elongation to failure, and the like) of the bound object.

### Post-Processing

In certain embodiments, post-processing (such as curing, drying, crosslinking, and the like) may be optionally performed to improve the mechanical properties of objects fabricated from build material powder and binder. In certain embodiments, the improvement of mechanical properties attained during the post-processing steps may reduce breakages of objects that can occur during the removal of unbound build material powder from the surfaces of the objects formed from binder and build material powder. This process of removing unbound build material powder (that is, powder which is not held or adhered to an object with binder) is often termed “depowdering”. As one skilled in the art may appreciate, several approaches may be pursued to depowder parts.

### Objects: Parts and Supports

Several types of objects may be printed using a binder jet printer. In certain embodiments, a single object may comprise a single part. In certain embodiments, a single object may comprise a series of parts connected with a mechanical linkage permitting relative motion (such as a hinge, slide, or other element). In certain embodiments, a single object may comprise a series of parts connected with a mechanical linkage in which motion is prohibited, substantially prohibited, or the parts are otherwise fully constrained in all directions of translation and rotation. In certain embodiments, a single object may comprise a series of parts connected with at least one mechanical linkage permitting motion in at least one direction, and prohibiting motion in at least one other direction (such as, for example, in a sliding mechanism permitting motion in a first sliding direction with constraint imposed in a second constraining direction orthogonal to the first direction). In certain embodiments, a single object may comprise a part and a supporting structure, where the supporting structure may be configured to touch, abut, hold, cradle, or otherwise contact the part at or through at least one point across opposed surfaces of the part and support structure. In certain embodiments, the support structure may provide a means of support to the part. In certain embodiments, the means of support may be mechanical, such that the support structure, through the at least one point, carries a stress or force transmitted through or imposed upon the part. In certain embodiments, the part and the support may be printed in a first configuration and brought to contact in a second configuration, where the second configuration enables the support structure to provide support to the part.

### Thermal Processing

Following binder jet printing and optional post-processing of the object, the object may be further subjected to thermal processing, according to certain embodiments. The thermal processing may include the steps of debinding and sintering of the object.

### Debinding

During debinding, binder is removed from the object. Debinding may be performed in any suitable chamber or enclosure. In certain embodiments, a suitable chamber or enclosure may include a means of heating the object, a means of providing a flow of process gas, a means of evacuating a process gas, and a means of controlling a pressure of the process gas, as will be appreciated by one skilled in the art.

Not being bound by theory, debinding may remove binder by a thermally activated process of evaporation, sublimation, combustion, oxidation, or degradation, according to certain embodiments. Depending upon the specific binder and build material powder materials in the object undergoing debinding, the debinding process may be tailored to achieve the desired amount of debinding.

In certain embodiments, the debinding process may begin at any temperature from the list of starting debinding temperatures: 200, 250, 300, 350, 400, or 450 degrees centigrade. In certain embodiments, the debinding process may end at any temperature from the list of ending debinding temperatures: 250, 300, 350, 400, 500, or 600 degrees centigrade. For example, a debind process may occur between 200 and 350 degrees centigrade, or may occur between 300 and 600 degrees centigrade. It should be understood by one skilled in the art that the starting debinding temperature will be less than the ending debinding temperature.

The debinding process may require the maintenance of a specific gaseous atmosphere surrounding the objects, according to certain embodiments. The gaseous atmosphere may include the gases argon, nitrogen, oxygen, hydrogen, helium, carbon dioxide, carbon monoxide, ammonia, methane, air, or the like. According to certain embodiments, the gaseous atmosphere may be a mixture of gases. According to certain embodiments, the gaseous atmosphere may be substantially absent and a vacuum may exist about the parts. According to certain embodiments, a gaseous atmosphere may be provided by a process gas.

The debinding process may require, or more optimally perform with a specific pressure or range of pressures of a process gas. According to certain embodiments, the pressure of the gaseous atmosphere during debinding may be equal to or may exceed 1 atmosphere. According to certain embodiments, the pressure of the gaseous atmosphere during debinding may be between 0.5 and 1 atmosphere. According to certain embodiments, the pressure of the gaseous atmosphere may be between 0.01 and 0.5 atmospheres. According to certain embodiments, the pressure of the gaseous atmosphere may be between 0.01 and 10 Torr. According to certain embodiments, the pressure of the gaseous atmosphere may be less than 0.01 Torr. In certain embodiments, a desired pressure may be maintained with a vacuum pump and a supply of process gas, where the volume of gas removed by the pump and the supply of process gas at least partially determine the pressure within the debind chamber.

### Sintering

Following the removal of at least a portion of the binder by the debinding process, the object may then be sintered, according to certain embodiments. In certain embodiments, the objects may be sintered without the removal of the binder, or without the binder removal step.

Not being bound by theory, during the process of sintering, the build material powder is heated to result in the joining of the build material powders to form a sintered object. The sintered object may exhibit a density larger than the density of the object prior to sintering, according to some embodiments. The object may be sintered without the melting of any build material powder, according to certain embodiments. The object may be sintered with the melting of only a portion of the build material powder, according to certain embodiments.

The process of sintering typically occurs in a sintering furnace, as will be appreciated by one skilled in the art. According to some embodiments, the sintering furnace may include a means of heating the object to be sintered. According to some embodiments, the sintering furnace may include a means of providing a flow of sintering process gas to the objects to be sintered, in such a way that the gaseous atmosphere around the objects to be sintered is at least partially controlled. According to some embodiments, the sintering furnace may include a means of controlling the pressure of a gaseous atmosphere around the objects during the sintering process (the “sintering pressure”). According to some embodiments, the means of controlling the pressure of a gaseous atmosphere around the objects during sintering may include a vacuum pump and at least one conduit to enable gaseous communication between a chamber housing the object to be sintered and the vacuum pump.

The gaseous atmosphere surrounding the object during sintering is often an important aspect of the sintering process. According to certain embodiments, the gaseous atmosphere may be comprised of hydrogen, helium, argon, nitrogen, carbon dioxide, carbon monoxide, methane, forming gas (a mixture of hydrogen and argon), ammonia, or air. According to certain embodiments, the gaseous atmosphere may be comprised of a mixture of gasses (95% nitrogen and 5% hydrogen by weight, for example). Careful selection of the gaseous atmosphere may promote certain mechanisms of sintering and lead to a desired amount of densification. As will be understood by one skilled in the art, the composition of the gaseous atmosphere surrounding the object during sintering may change during the sintering process, for example according to a predetermined schedule and in a coordinated fashion with the temperature, pressure, and flow rates as a function of time.

The pressure of the gaseous atmosphere surrounding the object during sintering is often an important aspect of the sintering process. According to certain embodiments, it is desirable to decrease the pressure in the sintering furnace to enhance the densification (that is, to increase the density) of an object undergoing sintering. According to certain embodiments, it is desirable to increase the pressure in the sintering furnace to enhance the densification (that is, to increase the density) of an object undergoing sintering. The selection of pressure is typically determined by the elements from which the build material powder is comprised in addition to the interaction of the elements with the gaseous atmosphere. In certain embodiments, the pressure of the gaseous atmosphere surrounding the object during sintering is at least 1 atmosphere and up to 5 atmospheres. In certain embodiments, the pressure of the gaseous atmosphere surrounding the object during sintering is at least 0.5 atmosphere and less than 1 atmosphere. In certain embodiments, the pressure of the gaseous atmosphere surrounding the object during sintering is at least 0.1 atmosphere and less than 0.5 atmosphere. In certain embodiments, the pressure of the gaseous atmosphere surrounding the object during sintering is at least 0.001 Torr atmosphere and less than 10 Torr. In certain embodiments, the pressure of the gaseous atmosphere surrounding the object during sintering is less than 0.001 Torr. As will be understood by one skilled in the art, the pressure of the gaseous atmosphere surrounding the object during sintering may change during the sintering process, for example according to a predetermined schedule and in a coordinated fashion with the temperature, composition, and flow rates as a function of time.

In some embodiments, the steps of debinding and sintering may occur sequentially or simultaneously in the same chamber, as part of a processing operation. For example, a single furnace may be used to first debind a part by controlling its temperature through starting and ending debind temperatures, and continuing to sintering temperatures without first cooling the part from the ending debind temperature.

### Build Material Powders

In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6Al-4V titanium, F75 Co-Cr-Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yttria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a binder jet printer may include a container to contain the build material powder and printed structures. The container may be moveable relative to the build material delivery and spreading mechanisms, and may also be indexable relative to an inkjet head or heads which deposit the binding agent in a desired pattern to form a slice of a 3D structure on the surface of a powder bed. As may be appreciated by one skilled in the art, the ability of the binder jet printer to accurately position and index the bed is crucial to the performance of the binder jet printer, and, specifically, is crucial to the layer-to-layer tolerance of the objects (or parts) produced by the binder jet printer.

In certain embodiments, a gas management system may be employed and configured to assist in certain aspects of the binder jet additive manufacturing process. A gas management system may include functionality such as (1) providing a source of process gas (which may be a single gaseous species or a mix of gaseous species), (2) metering the source of process gas such that the flow of the process gas is controlled to an input command provided by a user of the additive manufacturing process or a system configured to control certain aspects of the additive manufacturing process (which may include the gas management system), (3) controlling the pressure of a gas in a specific volume or region of a binder jet printer or component related to a system of binder jet additive manufacturing (such as, for example, a tube or connection between various components where one of the components may include a binder jet printer), (4) controlling a flow of process gas in conveyance loops, piping, tubes, or other connections purposed to provide a flow of process and a flow of build material powder, (5) recirculating an amount of process gas sourced from within a printer through a suitable separation or filtration mechanism and back to the printer (where the filtration mechanism may include a filtration mechanism to separate a build material powder from a gas, such as a cyclonic separator or a sieve). The listing here of functionalities corresponding to a gas management system should not be considered limiting—in certain embodiments, a gas management system may include further functionality as described in the certain embodiments.

The functions performed by a gas management system may relate to, or be somewhat dependent on various control parameters (either realized in the function of the gas management system or provided as instructions to direct the function of the gas management system). For example, in certain embodiments, control parameters may include a flow of a process gas sourced from a source of process gas, a pressure of a process gas, a flow of a recirculated gas, a mixture ratio of recirculated gas and process gas sourced from a source of process gas (where a mixture ratio may be defined as the amount of sourced process gas divided by the amount of recirculated gas, perhaps on a weight or mass basis, or on a basis using a measurement of standard volume), or any other suitable signal or variable relating to the function of a gas management system.

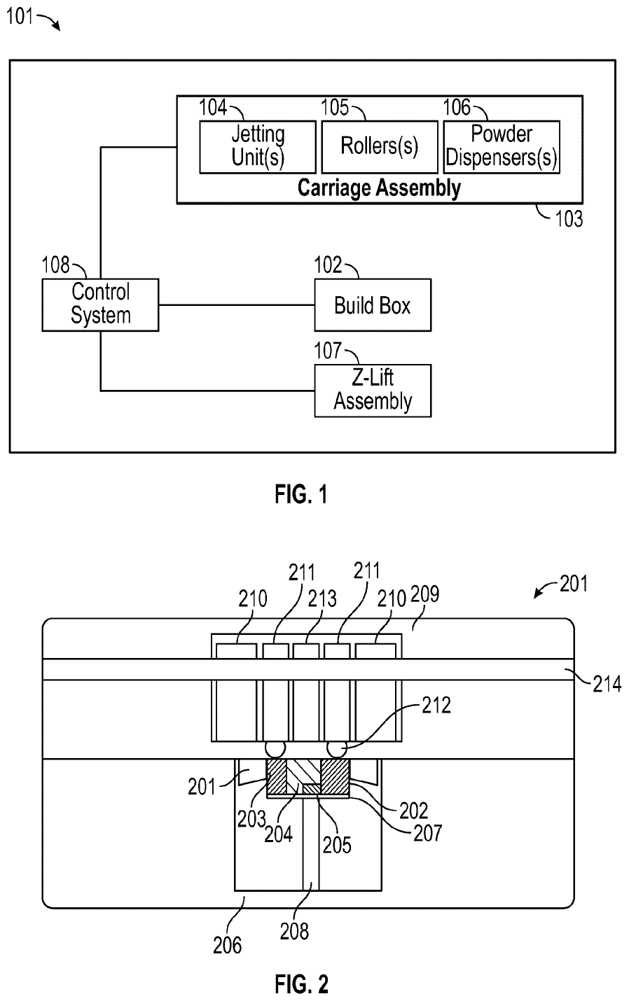

A binder jetting additive manufacturing system for which the present disclosure provides improvements includes a number of system components in a printer enclosure. With reference to FIG. 1, these include a build box 101 wherein articles are manufactured by the process of subsequent layers of powder that are bound in predetermined patterns of binder. A carriage assembly includes a jetting unit or units, a roller or rollers, and a powder dispenser or dispensers. The carriage assembly is moved relative to the build box during the printing process. In certain embodiments, the carriage assembly is traversed over the build box via an interface with a frame. The build box is moved vertically with respect to the carriage during the printing process so that each successive layer of powder may be spread and binder jetted onto the surface of the spread powder.

In certain embodiments, a gas management system may be controllable in concert with printing operations of the binder jet printer. Printing operations may include motion of the carriage assembly over the build box, the metering of powder from a powder dispenser onto a print surface, the spreading of powder along the build surface by a spreader, the deposition of binder onto the spread build material powder, or any other action performed by a printer during the fabrication of objects from a build material powder and a binder. In certain embodiments, for example, a gas management system may modulate a flow in a least some portion of the printer (such as a conveyance loop or similar gas flow pathway) in response to, or in anticipation of, the position of the carriage assembly as the carriage assembly traverses the build box. In further embodiments, the gas management system may modulate a flow in at least some portion of the printer (such as a conveyance loop or similar gas flow pathway) in response to, or in anticipation of, a spreading process. In further embodiments, the gas management system may modulate a flow in at least some portion of the printer (such as a conveyance loop or similar gas flow pathway) in response to, or in anticipation of, a deposition of binder onto the powder bed.

Applicants recognize that the various processes which occur during the binder jet printing process of objects from a build material powder may generate, or at least result in, the suspension and transport of build material powder in and throughout regions internal to the binder jet printer. In certain embodiments, the deposition process may result in powder becoming ejected, moved away from, or otherwise not contained in the powder bed or build box. For example, in certain embodiments, a binder jet process may be configured to accept one unit of build material powder per layer and an amount of build material powder may be deposited in excess of one unit of build material powder. In certain embodiments, a factor corresponding to between 1.1 and 6 units of build material powder may be provided onto the build bed where 1 unit of build material powder may be accepted in the layer of build material powder formed on the powder bed. The factor of build material powder may be referred to as an overflow amount, according to certain embodiments. Any amount of build material powder deposited in excess of the amount of build material required may be considered as excess powder.

In cases where excess build material is deposited on the powder bed, the excess build material powder may be removed to regions away from the powder bed, according to certain embodiments. The excess build material powder may be understood to have been removed via a removal process, in certain embodiments.

In certain embodiments, the removal process of the build material powder from the powder bed may result, or follow, from the metering process of the build material powder. In certain embodiments, excess powder resulting from a metering process is a source of stray powder within a binder jet printer.

In certain embodiments, the removal process of the build material powder from the powder bed may results, or follow, from the spreading process of the build material powder. The action of a spreader (such as a spreading roller, blade, protrusion, or other suitable mechanism) may push, convey, or otherwise eject an amount of build material powder during the process of spreading the build material powder during the formation of a layer of powder, in certain embodiments. By way of non-limiting example, and according to certain embodiments, a translating and rotating roller (where the rotation produces a relative velocity between the powder and roller surface that is in the same direction as the translating velocity of the roller) may suspend, transport, or otherwise kick-up powder away from the powder bed and in the printer via the momentum imparted to the powder by the translation and rotation of the roller. The amount of powder suspended may increase as the amount of overflow (as determined by the metering apparatus) is increased, and/or as the speed of the spreading process is increased, according to certain embodiments. In certain embodiments, excess powder resulting from a spreading process is a source of stray powder within a binder jet printer.

In certain embodiments, the removal process of the build material powder from the powder bed may result, or follow, from the process of depositing binder onto the build material powder. The process of depositing binder onto a powder bed may result in build material powder become ejected from the surface of the powder bed. In certain embodiments, it is undesirable for the powder to become ejected from the bed as the ejected powder may subsequently deposit or land on surfaces in the printer which are not intended to host, tolerate, or otherwise function with an amount of deposited powder. In certain embodiments, ejected powder is a source of stray powder within a binder jet printer.

In certain embodiments, the printer may undergo a refilling process where a metering assembly configured to deposit an amount of build material powder is refilled or charged with build material powder from a source of build material powder that may be internal or external to the printer. In certain embodiments, the refilling process may result in the generation, or deposition, of build material powder in regions of the printer away from the powder bed. This powder may be referred to as spilled powder. The build material powder deposited in regions of the printer away from the powder bed during the refilling process may be an undesirable byproduct of the refilling process, according to certain embodiments. In certain embodiments, the byproduct of the refilling process is a source of stray powder.

It may also be the case that build material powder is removed, ejected from, or otherwise displaced from the bed during any other operation of a binder jet printer. By way of non-limiting examples, build material could be removed, ejected from, or otherwise displaced due to manual or automated cleaning operations such as brushing, blowing, or vacuuming powder; or could result from relative motion between a carriage and a build powder bed. Build material powder which is not desired to be apart, or disconnected, from the powder bed may be considered a stray powder.

In certain embodiments, operating certain aspects of the binder jet printing process (such as metering, spreading, and binder deposition) at increasing speeds may result in an increase of excess build material powder.

Regardless of the source of excess build material powder, applicants recognize that it may be desirable to capture, or otherwise localize the amount of excess (or overflow amount of) powder to facilitate reuse of the powder and/or to maintain a clean environment within the binder jet printer. In a certain embodiment of a binder jet printer, it may be desirable to include a downdraft or downdraft assembly to at least partially capture any excess build material powder within the printer. In certain embodiments, a downdraft system including a downdraft assembly may be configured to accept excess build material by locating portions of the downdraft assembly in regions where excess powder is typically found, expected to be found, or deposited. In certain embodiments, the downdraft system may include a flow of gas directed into the downdraft assembly (such that gas is pulled into the downdraft assembly from the printer, directing ejected or suspended powder into the downdraft assembly).

In certain embodiments, materials comprising the build material powder may exhibit a sensitivity to certain gaseous environments. Oxygen and water sensitive materials including elements such as copper, aluminum, titanium, zirconium, hafnium, or silver may exhibit some form of degradation or reaction that may adversely affect aspects of the binder jet printing process or post-printing processes such as sintering. In certain embodiments, aspects of the binder jet printing process may include safety aspects, such as the tendency of a build material powder to catch fire or explode. In certain embodiments, aspects of the binder jet printing process may include oxidation of the build material powder.

In certain embodiments, it may be desirable to control the gaseous atmosphere and/or select the gases utilized in a downdraft system to account for sensitivities between the build material powder and specific gaseous atmospheres. For example, it may be desirable, in certain embodiments, to significantly exclude oxygen from the printer and downdraft system, in certain embodiments. In certain embodiments, it may be desirable to significantly exclude water vapor from the printer and downdraft system. In certain embodiments, it may be desirable to significantly exclude air or oxygen from the printer and downdraft system. Beyond the exclusion of specific gases or gaseous species, it may be desirable, in certain embodiments, to select a gas that is unreactive or substantially unreactive with the build material powder at the conditions within the printer and downdraft system. For example, it may be desired to utilize a noble gas (such as argon) within the printer and downdraft system, in certain embodiments. It may be desirable, in certain embodiments, to utilize a gas such as nitrogen with the printer and downdraft system.

Applicants recognize that the maintenance of a specific gaseous atmosphere with simultaneous flow of gas, where the flow of gas at least partially accomplishes conveyance of powder toward and through the downdraft system may create a substantial expense, in certain embodiments. To resolve this, in certain embodiments, a gas management system may be included to recirculate gas within the printer system. Such a gas management system may, in certain embodiments, (1) accept a process gas mixed with some amount of suspended build material powder from various positions within the printer and/or downdraft system, (2) separate the build material powder from the gas, and (3) return at least some amount of the gas separated from the build material powder to the print chamber. In certain embodiments, the gas management system may also monitor the gas at various positions to indicate an amount of species such as oxygen, water vapor, nitrogen, or argon. In certain embodiments, the various positions may include at least one of (1) the printer, (2) the downdraft system, (3) the separator, or (4) the gas return path to the printer.

With reference to FIG. 1, a binder jetting printer 101 includes a build box 102 where a part is to be manufactured. A carriage assembly 103 is moved relative to the build box 102 to deposit successive layers of build material powder and binder to form parts. In certain embodiments, the binder jetting printer 101 can be used to manufacture metal parts. In these instances, the build material powder is metal powder, and the part is later sintered to densify the part. The carriage assembly includes jetting unit(s) 104 for depositing binder, roller(s) 105 for spreading powder layers prior to binder jetting and powder dispenser(s) 106 which meter build material powder for successively printed layers. In alternate embodiments, build material powder may be metered from feed pistons and spread across the build box. In the embodiment of FIG. 1, the printer 101 includes a Z-lift assembly 107 which moves a build platen with the build box down as successive layers are printed. A control system 108 controls the various elements of the binder jetting printer 101.

FIG. 2 depicts a side cutaway view of a binder jetting printer 200. A build box 202 contains loose powder 203 and a part 204 being manufactured and potentially support structures 205. A Z-lift assembly 206 is configured to raise and lower the build box and build platen 207 to facilitate the printing process. A lift 208 raises and lowers the build platen 207. A print carriage 209 traverses relative to the build box. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components for use in jetting. In the embodiment, printing is bi-directional, i.e., in a first direction-left to right with reference to the figure, and then from right to left. To facilitate bi-directional printing, the depicted carriage 209 includes powder dispensing units 210, steamer units 211, a jetting unit 213 and roller units 214 having rollers 215.

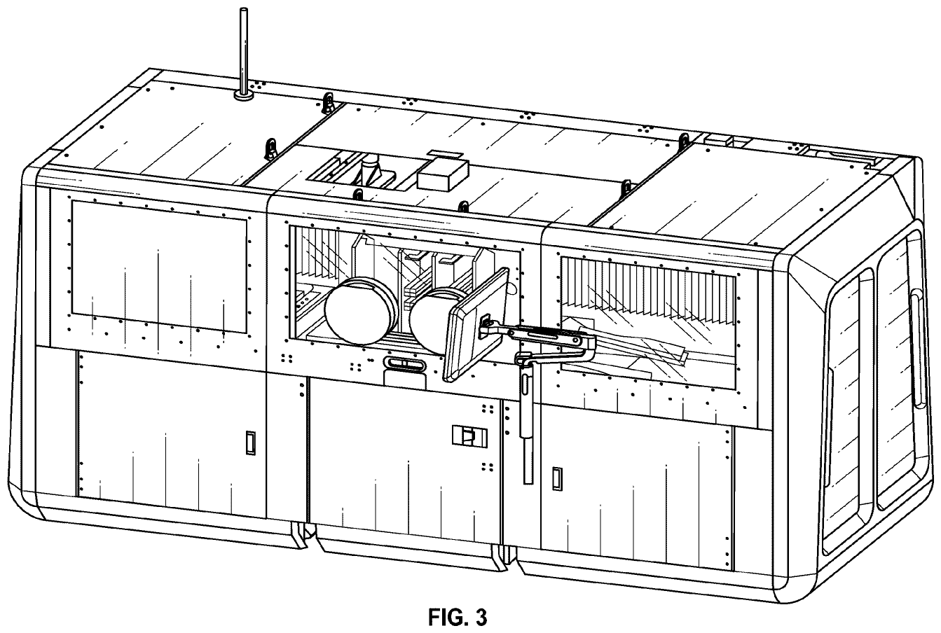

FIG. 3 is a perspective view of an embodiment binder jetting printer.

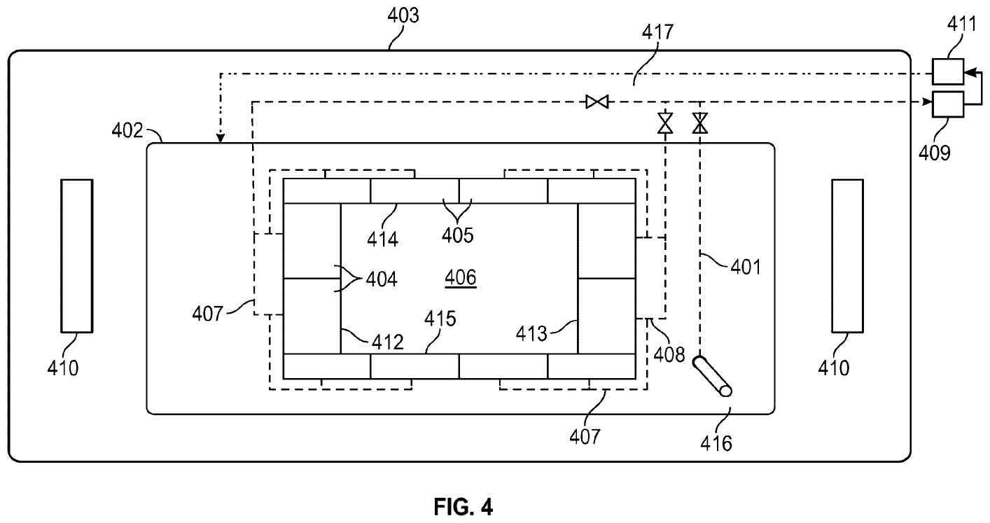

FIG. 4 depicts a top schematic view of an embodiment downdraft gas management system 401 servicing a printing area 402 of a binder jetting printer 403. A plurality of powder collection chutes includes primary powder chutes 404 and a secondary chutes 405 together form a downdraft system. The powder chutes are disposed in an interior of the binder jetting printer 403 and adjacent to a print deck 406. The downdraft system of primary chutes 404 and secondary chutes 405 are configured to receive an amount of excess build material powder dislodged from the print deck 406 by a powder spreading process. The build material powder dislodged from the print deck 406 includes excess powder intentionally ejected from recoating operations as well as powder spilled as an inevitable side effect of ongoing printing or refilling of the metering apparatus. A pneumatic conveyance system 407 including conveyance plumbing tubes 408 provides gaseous communication between the downdraft system and a powder collection unit 409. A gas management system includes inflow ports 410 that provide a flow of process gas into the printing area 402, through the downdraft system and the pneumatic conveyance system 407 at a rate sufficient to convey the excess build material powder received by the downdraft system from the downdraft system through the pneumatic conveyance system 407 to the powder collection unit 409. A sufficient rate may be a rate such that a particle of build material powder is carried a distance of between 0.1 and 1 meter, or between 0.5 and 2 meters, or between 0.5 and 10 meters, or any other distance required for the conveyance of build material powder. In some embodiments, the inflow ports 410 may be configured to incorporate a diffuser or other configuration for controlling the flow and distribution of the inflow gas, such that the flow of the gas does not cause undue disturbance to the binder jet printing process, such as disturbing the trajectory of the binder droplets ejected from the printheads, or disturb the build material powder during metering, spreading, or in the deposited layer in the build box. The powder collection unit 409 is configured to separate the excess build material powder from the flow of process gas and collect the excess build material powder. A recirculation system 411 which may include a blower recirculates the process gas separated from the excess build material powder in the powder collection unit 409.

In certain embodiments, the downdraft system may include multiple chutes. Excess build material powder initially deposited onto, above, or near the surface of the build volume to form a layer may spill, leave, or otherwise transit in several directions away from the build surface, according to certain embodiments. In certain embodiments, then, it may be desirable to endow the downdraft system with multiple chutes to collect at least the ejected, excess, and spilled build material powder in the various positions where the build material powder may be directed toward as a result of the binder jet printing process. By way of non-limiting example, in certain embodiments, chutes may be positioned at locations such that they are beneath the powder dispensing apparatus during the refilling of the powder dispensing apparatus. In this way, powder which escapes the dispensing apparatus during the refilling may be captured by the chute, in certain embodiments.

In addition to the above-mentioned advantage of reusing process gas having been separated from the build material powder to reduce system operation cost, it will be recognized by one of ordinary skill in the art that reuse of build material powder may also be desirable to reduce the amount of new build material powder required for the binder jet printing of parts. Thus the powder which is separated in the powder collection unit 409 may be returned to the printer, with or without intermediate processing to restore desirable powder properties such as powder cohesion, moisture level, degree of agglomeration, and the like.

The powder collection unit 409 may be a cyclonic separator, a filter separator, or the like. The primary powder chutes 404 are disposed at a first end 412 and a second end 413 of the print deck 406 that are perpendicular to a direction of relative traverse of a print module. The secondary powder chutes 405 are disposed at a third end 414 and fourth end 415 of the print deck that are parallel to a direction of relative traverse of a print module. The pneumatic conveyance system 407 may further receive build material from a vacuum wand 416 useful to clean build material powder from an interior of the binder jetting printer 403. In the embodiment of FIG. 4 the powder collection unit 408 is external to binder jetting printer 403, though in alternate embodiments it may be incorporated as a component of binder jetting printer 403. Valves 417 are configured to selectively isolate conveyance pluming tubes. By selective actuation of any of the valves 417, the flow of process gas through one of the primary chutes 404, secondary chutes 405, or the vacuum wand 416 may be increased, decreased, or turned off. As will be understood by one skilled in the art, increasing a flow rate to one branch of the multiply-branched pneumatic conveyance system may be useful for removing clogs or obstructions, for example of build material powder which has settled in the conveyance tubes.

In certain embodiments, a chute may be designed to promote the motion of a build material powder located on the surface of a chute. As may be appreciated by one skilled in the art, surfaces in contact with a granular material, such as a build material powder, may promote or permit the motion of the build material powder on the surface of the chute depending upon at least one of the size of the powders from which the build material powder is comprised, cohesive attributes of the build material powder, the density of the build material powder, the packing fraction of the build material powder, the surface finish (or smoothness) of the surface of the chute, the inclination (or angle) of the chute relative to the direction of the exertion of a gravitational force, and any other forces imposed upon the build material powder while in contact with the chute (such as a shear force driven by a flow of gas, or vibratory forces from the oscillation of a surface of the chute). In an embodiment, the walls of the chute may be constructed of a stainless steel sheet metal, having a surface finish consistent with typical sheet metal construction, as will be understood by one of ordinary skill in the art. In some embodiments, the chutes may be constructed to have a chute angle of not less than 45 degrees with respect to horizontal, or, in at least one example, not less than 70 degrees from horizontal. In some embodiments, the chutes may be constructed to have an asymmetrical form, where the angle of a side disposed to receive overflow powder during a printing operation may have a steeper (that is, more nearly vertical) angle than a surface which may receive only incidental powder.

In certain embodiments, a chute may be designed to promote substantially more uniform gas flow velocity profiles within the chute. In some embodiments, uniformity of flow may be created by the use of fins, baffles, grates, gratings, or other features within or on the chute, which may permit the passage of powder and which further redirect the gas flow to be uniform throughout the

[symbol]

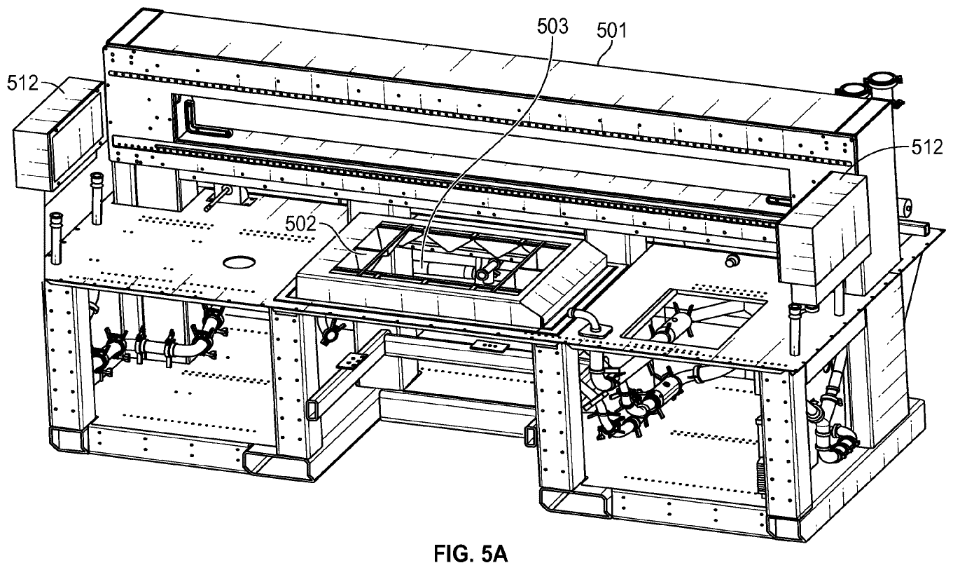

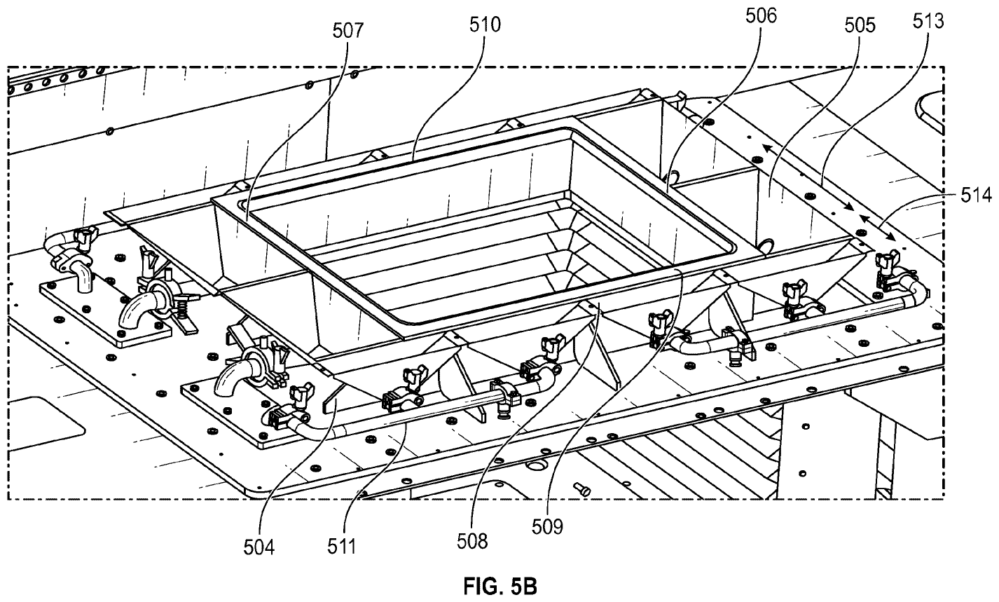

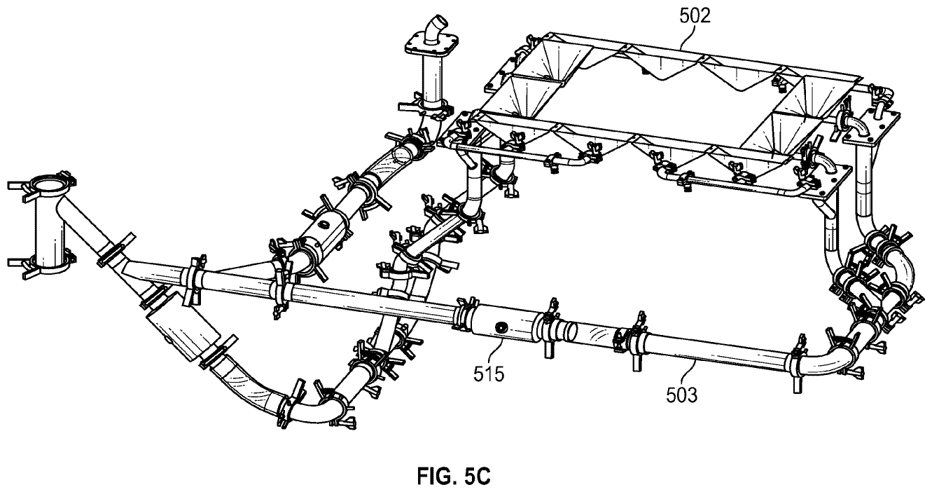

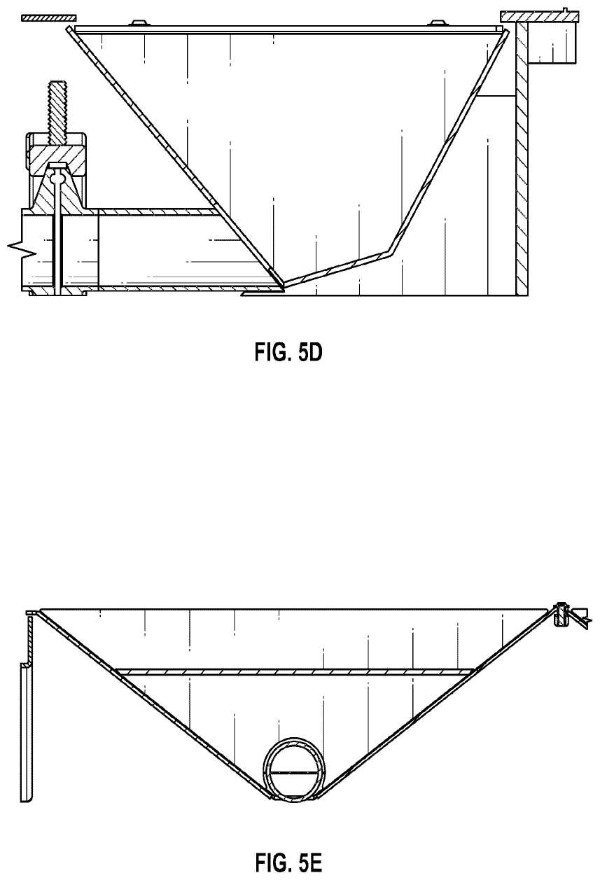

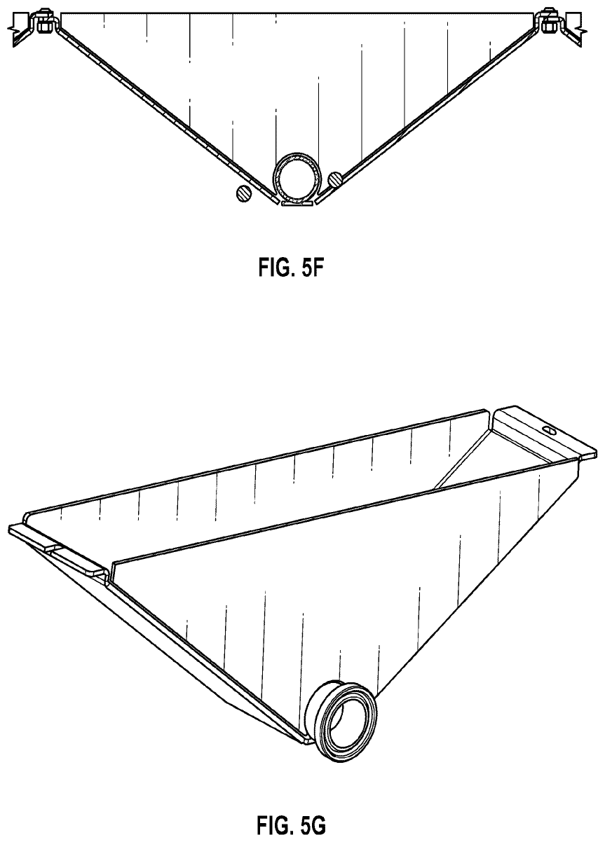

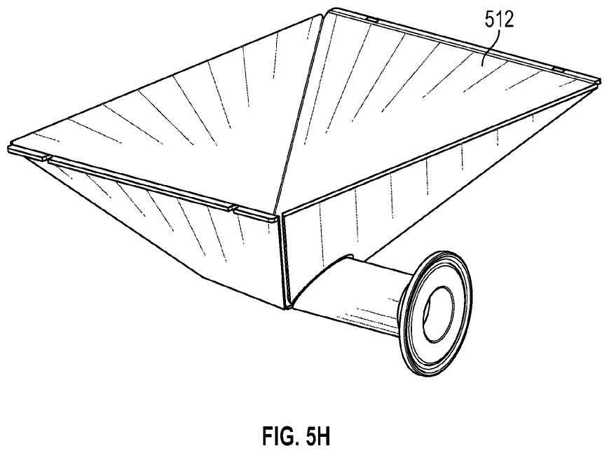

FIG. 5 depicts an interior of a binder jetting printer 501 with various components removed for visual ease of understanding. A downdraft system 502 receives excess build material powder from a build area 503 that when assembled is where a build platen of a build box is presented that receives layers of build material powder for printing. FIG. 5B shows a close-up of the downdraft system 502 with shrouding removed as including an arrangement of powder collection chutes 504 configured to receive an amount of excess build material powder dislodged from the print deck by a binder jetting printing process. Primary powder chutes 505 are disposed at a first end 506 and a second end 507 perpendicular to a direction of relative traverse of a print module. Secondary powder chutes 508 are disposed at a third end 509 and a fourth end 510 parallel to a direction of relative traverse of a print module. Each of the powder collection chutes 504 includes a plurality of sloped walls configured to facilitate delivery of excess build material powder received to the powder collection chutes to conveyance plumbing tubes 511. As visible particularly in FIG. 5B and FIGS. 5D-5H each of the powder collection chutes 504 includes four walls 512 that are trapezoidal in shape. In at least one example, at least two of the walls of each of the powder collection chutes 504 have a slope theta of less than or equal to 66 degrees and, in at least one example, a slope theta of less than or equal to 30 degrees. Such angling facilitates the movement of powder which may otherwise collect on walls of lesser slope. As visible particularly in FIGS. 5E-H each of the powder collection chutes exits the respective powder collection chute substantially parallel to the print deck. Alternatively, the powder collection chute exits may be made through the floor surfaces of the collection chutes and be vertical as typical of drains or disposed at another angle suitable for facilitating flow of powder and gas. A gas management system 512 (See FIG. 5A) is configured to provide a flow of process gas through each of the powder collection chutes. Each of the primary powder chutes 505 has a length 513 larger than a length 514 of each of the secondary powder chutes 508.

FIG. 5C depicts an unobstructed view of the downdraft system 502, conveyance plumbing tubes 511 and valves 515.

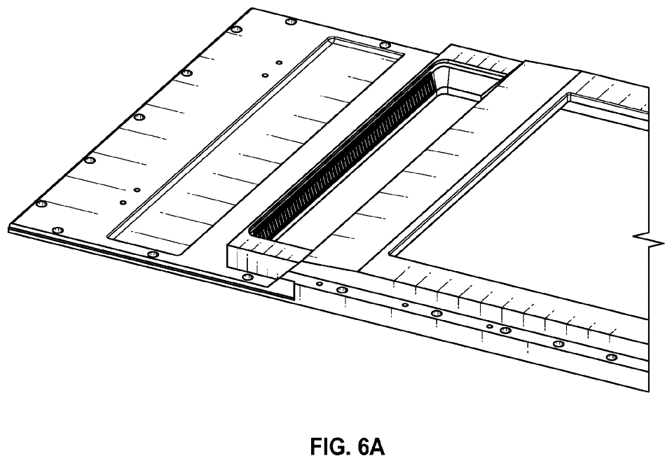

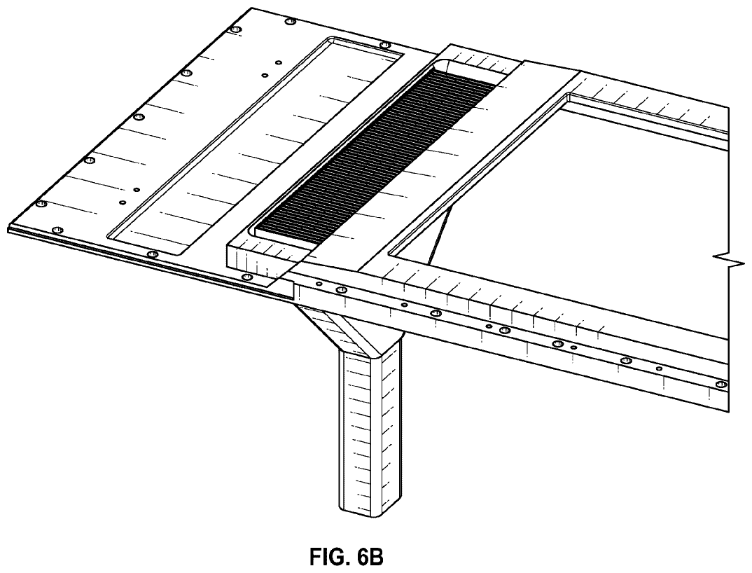

FIG. 6A depicts an open chute system having side baffles to increase air flow velocity. FIG. 6B depicts adjustable spacing fins to change the percentage of the duct that is open. Lastly, FIG. 6C depicts a small gap around the perimeter of the baffle to increase air flow at the edges.

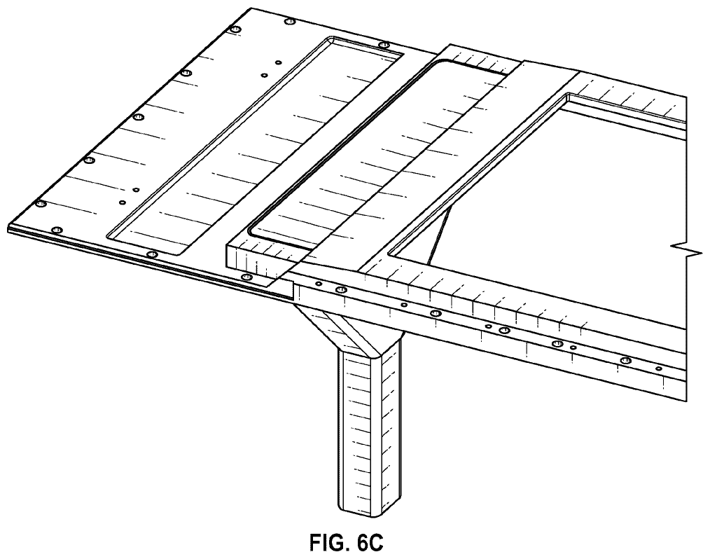

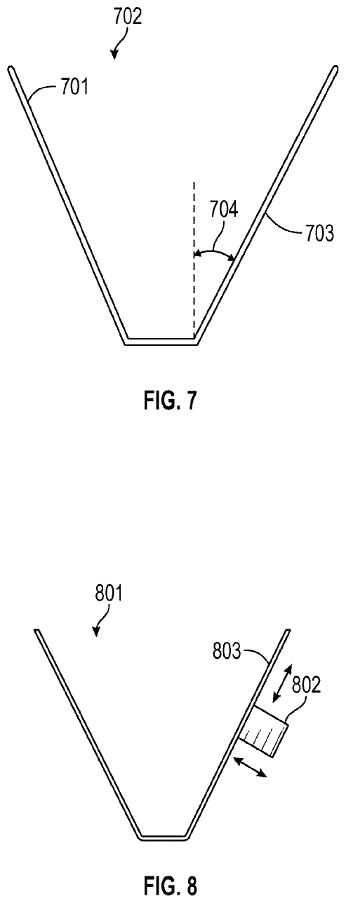

FIG. 7 depicts an idealized chute 701 having an interior 702 and an exterior 703. A theta angle 704 of the chute's wall is the angle between the wall and a vertical axis, indicating a steepness of the slope of the chute.

FIG. 8 depicts an idealized chute 801 having a vibrator 802 configured to induce vibration of the chute walls 803 to aid preventing build up of powder on the chute walls 803. This feature may be incorporated into the chutes depicted in the other Figs. and particularly the embodiment shown in FIGS. 5A-5H. In certain embodiments, a vibration of the chute may be desired to agitate, bring to move, or otherwise assist in the conveyance of a build material powder that would otherwise not be in a state of flow or be in a state where the rate of flow is less than desired. Not to be bound by theory, one skilled in the art will appreciate that some amount of agitation may generate a force which in comparison to cohesive, frictional, or gravitational forces opposing the motion of the powder, in some cases slight and in other cases large, may aid in dislodging the build material powder and bring about a state of flow.

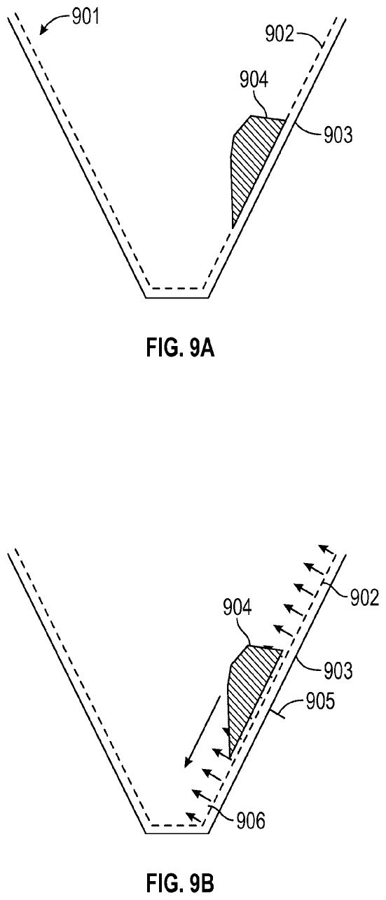

FIG. 9A depicts an idealized chute 901 having an inner permeable wall 902 and an outer impermeable wall 903. In FIG. 9A, the chute 901 is suffering from a build up of excess build material powder 904 (or, in certain circumstances, a combination of excess build material powder and excess binder). This feature may be incorporated into the chutes depicted in the other Figs. and particularly the embodiment shown in FIGS. 5A-5H.

FIG. 9B depicts the same chute 901 of FIG. 9A, wherein a pressurized gas is applied by means of an inlet 905 to the space between the inner permeable wall 902 and the outer impermeable wall 903. The pressurized gas may then escape through the inner permeable wall 902, creating a boundary layer of gas 906, which may serve to reduce the friction between the build material powder 904 and the inner wall 902. This reduction of friction may induce the build material powder 904 to fall down the chute and be collected. In certain embodiments, the pore size of the inner permeable wall may be smaller than the average diameter of grains comprising the build material powder. In certain embodiments, a pressure of gas may be applied across the permeable wall such that a state of gas flow is established from the space between the permeable and impermeable walls directed outward through the permeable wall. In certain embodiments, a flow may be applied in a pulsing, cyclic, or otherwise irregular manner through the permeable wall.

What is claimed is:

1. A powder collection system for use in binder jetting additive manufacturing, comprising:
a downdraft system including at least one powder collection chute disposed in an interior of a binder jetting printer and adjacent to a print deck, the downdraft system configured to receive an amount of excess build material powder dislodged from the print deck by a powder spreading process;
a pneumatic conveyance system including at least one conveyance plumbing tube providing gaseous communication between the downdraft system and a powder collection unit;
a gas management system configured to provide a flow of process gas through the downdraft system and the pneumatic conveyance system at a rate sufficient to convey the excess build material powder received by the downdraft system from the downdraft system through the pneumatical conveyance system to the powder collection unit; and
wherein the powder collection unit is configured to separate the excess build material powder from the flow of process gas and collect the excess build material powder.

2. The powder collection system of claim 1 wherein the gas management system recirculates the process gas separated from the excess build material powder in the powder collection unit.

3. The powder collection system of claim 1 wherein the powder collection unit includes one of a cyclonic separator and a filter separator.

4. The powder collection system of claim 1 wherein the build material powder dislodged from the print deck includes at least one of excess powder and spilled powder.

5. The powder collection system of claim 1 wherein the at least one powder collection chute includes at least one baffle.

6. The powder collection system of claim 1 wherein the at least one powder collection chutes includes a plurality of primary powder chutes and a plurality of secondary chutes.

7. The powder collection system of claim 6 wherein the primary powder chutes are disposed at a first end and a second end of the print deck that are perpendicular to a direction of relative traverse of a print module.

8. The powder collection system of claim 6 wherein the secondary powder chutes are disposed at a third end and fourth end of the print deck that are parallel to a direction of relative traverse of a print module.

9. The powder collection system of claim 1 wherein at least one of the conveyance plumbing tubes includes a valve configured to isolate the respective conveyance plumbing tube.

10. The powder collection system of claim 1 wherein the powder collection unit is external to binder jetting printer.

11. A downdraft powder collection system, comprising:
an arrangement of powder collection chutes disposed adjacent to a print deck and configured to receive an amount of excess build material powder dislodged from the print deck by a binder jetting printing process; and
wherein each powder collection chute includes a plurality of sloped walls configured to facilitate delivery of excess build material powder received to the respective powder collection chute to a conveyance plumbing tube.

12. The downdraft powder collection system of claim 11 wherein each powder collection chute includes four walls that are trapezoidal in shape.

13. The downdraft powder collection system of claim 11 wherein at least two of the walls have a slope theta of less than or equal to 66 degrees, or
wherein at least two of the walls have a slope theta of less than or equal to 30 degrees.

14. (canceled)

15. The downdraft powder collection system of claim 11 wherein the conveyance plumbing tube of each powder collection chute exits the respective powder collection chute substantially parallel to the print deck.

16. The powder collection system of claim 11 wherein the arrangement of powder collection chutes includes a plurality of primary powder chutes and a plurality of secondary chutes,
wherein the primary powder chutes are disposed at a first end and a second end of the print deck that are perpendicular to a direction of relative traverse of a print module.

17. (canceled)

18. The powder collection system of claim 15, further comprising:
wherein the primary powder chutes each have a length parallel to the direction of relative traverse of the print module;
wherein the secondary powder chutes each have a length perpendicular to the direction of relative traverse of the print module; and
wherein the lengths of each of the primary powder chutes are larger than the lengths of each of the secondary powder chutes.

19. The powder collection system of claim 14 wherein the secondary powder chutes are disposed at a third end and fourth end of the print deck that are parallel to a direction of relative traverse of a print module.

20. The powder collection system of claim 11, further comprising:
a gas management system configured to provide a flow of process gas through each of the powder collection chutes,
wherein at least one of the powder collection chutes includes a vibration system configured to provide vibration to facilitate powder delivery to a conveyance plumbing tube.

21. (canceled)

22. A gas recirculation system for use in the binder jetting additive manufacturing of objects from a build material powder, comprising:
a collection chute, disposed in an interior of a binder jetting printer, the collection chute configured to accept, via a chute opening, a mixture of excess build material powder, excess binder and process gas,
a pneumatic conveyance system including a powder collection unit, and a conveyance plumbing tube providing gaseous communication between the collection chute and the powder collection unit,
a gas management system configured to provide a flow of process gas through the collection chute and the pneumatic conveyance system at a rate sufficient to convey the excess build material powder received at the chute opening from the collection chute through the pneumatical conveyance system to the powder collection unit; and
wherein the powder collection unit is configured to:
(1) create a separated stream of process gas by separating the excess build material powder from the flow of process gas, and
(2) collect the excess build material powder and recirculate at least a portion of the separated stream of process gas to the gas management system.

23. The gas recirculation system of claim 22 where the excess build material powder includes at least build material powder ejected during a powder spreading process, and
wherein the collection chute includes at least one diffuser configured to introduce an amount of return gas from the gas management system.

24. (canceled)
